(19) United States
(12) Patent Application Publication
(10) Pub. No.: US 2014/0380417 A1
(43) Pub. Date: Dec. 25, 2014

(54) Methods And Devices For Controlling Access To Distributed Resources

(71) Applicant: Alcatel Lucent, Paris (FR)

(72) Inventor: Tommaso Cucinotta, Blanchardstown (IE)

(73) Assignee: Alcatel Lucent, Paris (FR)

(21) Appl. No.: 13/926,832

(22) Filed: Jun. 25, 2013

(51) Int. Cl. H04L 29/06

(52) U.S. Cl. CPC H04L 63/101
USPC 726/3

(57) ABSTRACT

Access to distributed resources of a network may be controlled by access control data structures that may be customized for a given user or application by taking into consideration a plurality of factors, such as the users and applications seeking access, and the status of a given user or application session. A combination of such parameters may dictate a strict or lenient authentication process.

### BACKGROUND

Traditional methods for limiting access to communication resources rely upon restricting multiple users to a single server, or restricting a single user to specific applications. These methods are ineffective, however, in a cloud-based environment where multiple communication resources may be distributed across multiple devices, and may need to be accessed by multiple users and/or multiple applications.

Accordingly, it is desirable to provide methods and related devices that control access to distributed resources in a cloud-based environment.

### SUMMARY

Exemplary embodiments of methods and devices for controlling access to communication resources are provided.

In one embodiment a method for controlling access to distributed resources may comprise: determining a session status at a device within a cloud-based network; determining an authentication process based on the determined session status in accordance with an access control data structure; and controlling access to one or more distributed resources based on the data structure. The access control data structure may comprise one or more access control lists (ACLs), and the device may be selected from the group consisting of at least a local device, and a network device, for example. The method may further comprise granting or denying a user or application access to the one or more distributed resources based on the access control data structure, where the application may comprises a content distribution application. Yet further the method may additional comprise receiving the access control data structure at a device, and associating the received access control data structure with an operating system (OS) of the device, where the OS may be selected from the group consisting of at least a Linux based OS, a UNIX based OS, a Microsoft based OS, and an Apple based OS.

In another embodiment of the invention, a method may comprise determining a next session status; determining a next authentication process based on the determined next session status in accordance with the access control data structure; and controlling access to the one or more distributed resources based on the access control data structure.

In the event there are conflicting data structures that may be applied the method may further comprise selecting a specific access control data structure over a less specific data structure upon detection of a conflict between data structures.

In addition to controlling access to distributed resources, in another embodiment a method may comprise receiving content at a device from one or more additional devices within the cloud-based network.

While the embodiments described above relate to the reception of access control data structures further embodiments relate to the generation of such structures. For example, one exemplary method may comprise generating an access control data structure at a device within a cloud-based network (e.g., local device, network device), the structure associated with one or more parameters selected from the group consisting of at least users, applications (e.g., content distribution application), authentication processes and distributed resources; and distributing the access control data structure to one or more additional devices within the cloud-based network, such as devices selected from the group consisting of at least local devices, and network devices. Rather than distribute the entire structure, in an alternative embodiment only a portion of the access control data structure may be distributed to one of the additional devices within the cloud-based network. As before, one example of an access control data structure is one or more access control lists (ACLs). The method may further comprise distributing content to the one or more additional devices.

The present invention also provides devices for controlling access to distributed resources in addition to the methods described above and herein. For example one device (e.g., a local device or network device) may be operable to: determine a session status; determine an authentication process based on the determined session status in accordance with an access control data structure (e.g., one or more ACLs); and control access to one or more distributed resources based on the data structure. The device may be further operable to receive the access control data structure; and associate the received data structure with an OS, such as one selected from the group consisting of at least a Linux based OS, a UNIX based OS, a Microsoft based OS, and an Apple based OS.

In a further embodiment the device may be operable to grant or deny a user or application access to the one or more distributed resources based on the access control data structure, where the application may comprise a content distribution application.

As with the above described methods, the present invention provides for related devices that are operable to determine a next session status; determine a next authentication process based on the determined next session status in accordance with the access control data structure; and control access to the one or more distributed resources based on the access control data structure.

In the event there are conflicting data structures, a device may be operable to select a specific access control data structure over a less specific data structure upon detection of a conflict between data structures.

In addition to controlling access to distributed resources, in another embodiment the device may be operable to receive content from one or more additional devices within the cloud-based network.

While the embodiments described above relate to devices that receive access control data structures further embodiments relate to devices that generate such structures. For example, one device (e.g., local device, network device) may be operable to generate an access control data structure (e.g., ACLs), the structure associated with one or more parameters selected from the group consisting of at least users, applications (e.g., a content distribution application), authentication processes and distributed resources; and distribute the entire access control data structure, or a portion of such a data structure, to one or more additional devices within a cloud-based network. The one or more additional devices may be selected from the group consisting of at least local devices, and network devices.

The device may be further operable to distribute content to the one or more additional devices.

Additional features of the present invention will be apparent from the following detailed description and appended drawings.

### BRIEF DESCRIPTION OF THE DRAWINGS

FIG. 1 depicts a simplified block diagram of a network, such as a cloud-based network, according to an embodiment of the invention.

FIG. 2a depicts exemplary parameters that may be considered in configuring an access control data structure according to embodiments of the invention.

FIG. 2b depicts additional exemplary parameters that may be considered in configuring an access control data structure according to embodiments of the invention.

FIG. 3 depicts exemplary access control lists (ACLs) according to the present invention.

### DETAILED DESCRIPTION, INCLUDING EXAMPLES

Exemplary embodiments of methods and devices for controlling access to resources are described herein in detail and shown by way of example in the drawings. Throughout the following description and drawings, like reference numbers/characters refer to like elements.

It should be understood that, although specific exemplary embodiments are discussed herein there is no intent to limit the scope of the present invention to such embodiments. To the contrary, it should be understood that the exemplary embodiments discussed herein are for illustrative purposes, and that modified and alternative embodiments may be implemented without departing from the scope of the present invention.

Specific structural and functional details disclosed herein are merely representative for purposes of describing the exemplary embodiments. The inventions, however, may be embodied in many alternate forms and should not be construed as being limited to the embodiments set forth herein.

It should be noted that some exemplary embodiments are described as processes or methods (collectively “method” or “methods”). Although a method may be described as a series of sequential steps, the steps may be performed in parallel, concurrently or simultaneously. In addition, the order of each step within a method may be re-arranged. A method may be terminated when completed, and may also include additional steps not described herein.

It should be understood that when the terms “generating”, “distributing”, “controlling”, “determining”, “receiving”, “detecting”, “granting”, “denying” as well as other action or functional terms and their various tenses are used herein, that such actions or functions may be implemented or completed by one or more processors (collectively referred to as “processor”) operable to execute instructions stored in one or more memories (collectively referred to as “memory”). Such a processor and memory may be a part of a larger device (e.g., network device (server), access device, local client devices such as laptops, desktops, tablets and smartphones).

As used herein, the term “and/or” includes any and all combinations of one or more of the associated listed items. It should be understood that when an element is referred to, or described or depicted as being “connected” to another element it may be directly connected to the other element, or intervening elements may be present, unless otherwise specified. Other words used to describe connective or spatial relationships between elements or components should be interpreted in a like fashion. As used herein, the singular forms “a,” “an” and “the” are not intended to include the plural form, unless the context indicates otherwise.

As used herein, the term “embodiment” refers to an embodiment of the present invention.

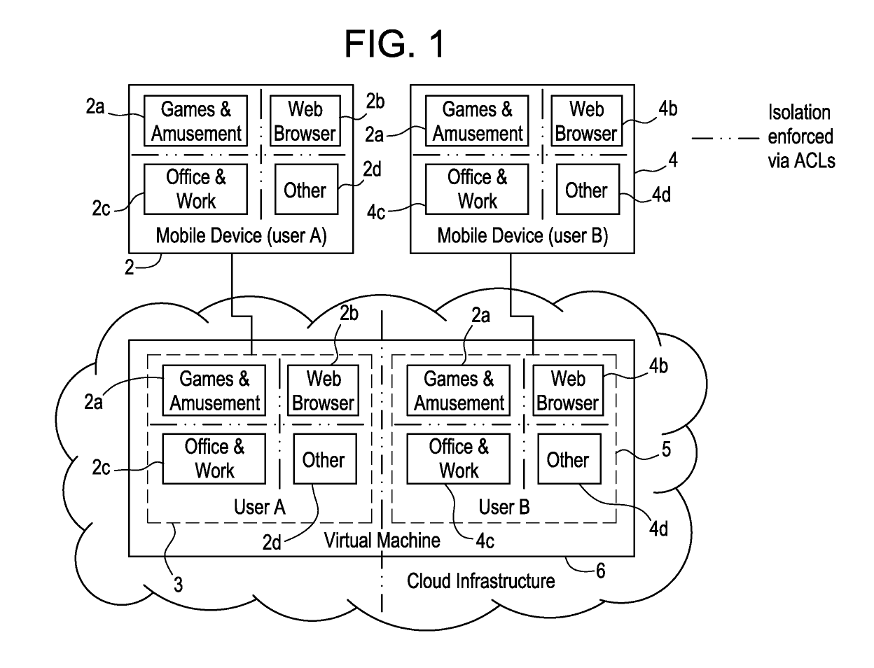

Referring now to FIG. 1 there is depicted a simplified block diagram of a network 1. In an embodiment of the invention the network 1 may comprise a cloud-based network, for example. The network 1 may comprise one or more different types of devices, such as devices selected from at least a local device, and a network device, for example. As shown network 1 may comprise two local devices 2,4 and one network device 6. Each of the devices shown in FIG. 1 may be wired and/or wireless devices that may be connected via wired and/or wireless means known in the art. Though only two local devices, and one network device is shown in FIG. 1 it should be understood that a plurality of each type of device may be included, and connected, within the network 1. Each of the devices shown in FIG. 1 may comprise a processor operable to execute instructions stored in associated memory to complete functions, features and methods in accordance with embodiments of the present invention. For the sake of simplifying the description of the invention the included processor(s) and memory(s) are not shown in FIG. 1. In one embodiment of the invention the network device 6 may comprise sections 3,5 that “mirror” devices 2,4. That is, sections 3,5 may be configured similar to devices 2,4 such that any data, applications, authentication information, etc., that is stored or used by device 2 may be stored and used by section 3 acting on behalf of device 2 and, similarly, any data, applications, authentication information, etc., that is stored or used by device 4 may be stored and used by section 5 acting on behalf of device 4. Sections 3,5 may be referred to as “virtual machines” by those in the art. In slightly more detail, assuming that device 2 may comprise an operating system (OS), this OS may be operable to control a number of different applications 2a through 2d, each of which may generate data and each of which may be associated with authentication information, for example. In the cloud-based network 1 the operation of the OS may be mirrored by similar systems operating within section 3 to control a number of similar applications each of which mirrors an application 2a through 2d in device 2 and may, in addition, operate on behalf of such a device 2 to generate new data and new authentication information that may eventually be stored within, or applied to the operation of, device 2. Similarly, device 4 may be associated with its own virtual machine, section 5. As depicted in FIG. 1, section 2a of device 2 may comprise a distributed application because it is present or distributed within each of the devices 2, 4 and 6, for example.

In accordance with the present invention, the devices shown in FIG. 1 may be operable to complete innovative functions, features and processes that overcome the limitations of traditional access control methodologies. In particular, the devices shown in FIG. 1 may be involved in controlling access to communication resources that may be included within one or more of the devices shown in FIG. 1, and/or within other devices within the network 1, and/or within devices that may be outside the network 1 (i.e., within another network). That is, in an embodiment of the invention the resources may be “distributed” throughout the network 1 or other networks, for example, and may therefore be referred to as “distributed resources”. By way of example, “distributed resources” may take the form of stored data (e.g., text, audio, video, measurements or some combination of the four), input or output devices (e.g., microphones, web-based cameras, speakers) and their related drivers, network interfaces (modems, routers, switches), communication devices (telephones, computers, printers, facsimile machines) and file system parameters (file extensions, folders, documents, pictures, videos, audio files), to name just a few examples of the types of distributed resources that can be controlled by the inventive methods and devices.

It should be understood that a distributed resource may be distributed in a number of different ways. For example, a distributed resource may comprise video files that may be generated by one or more devices within network 1 and then distributed (sent, forwarded) to a subset of all of the devices within network 1 that are authorized to receive the video files, or all of the devices within network 1 provided each is authorized to receive the video files, or one or more devices outside of network 1 that are authorized to receive the video files. Upon receipt, the video files may be stored and accessed by a device that is authorized to have access to the video files, for example. It is a challenge to provide effective methods for controlling access to such distributed resources. Nonetheless, the inventor discovered innovative methods and related devices for doing so.

In embodiments of the invention, innovative distributed access control data structures may be used to control access to distributed resources. One example of an access control, data structure is one or more access control lists (ACLs). An ACL may comprise a set of access control rules (ACRs) that may govern access to resources. More particularly, the present invention provides innovative access control data structures, such as innovative ACLs and ACRs, which may be applied in the multiple distributed application/multiple user/multiple device environment prevalent within cloud-based networks. In general, an ACR may grant or deny a user or an application (or a group of users and applications) access to one or more resources. For example, one ACR may be to “grant users access to a content distribution application 2a via local devices 2,4 provided a password recognition authentication process is completed”. In accordance with embodiments of the invention, and as described in more detail herein, an ACL and its associated ACRs may be generated by one or more of the devices shown in FIG. 1, and then distributed to one or more devices also shown in FIG. 1 where they may be used to control access to distributed resources.

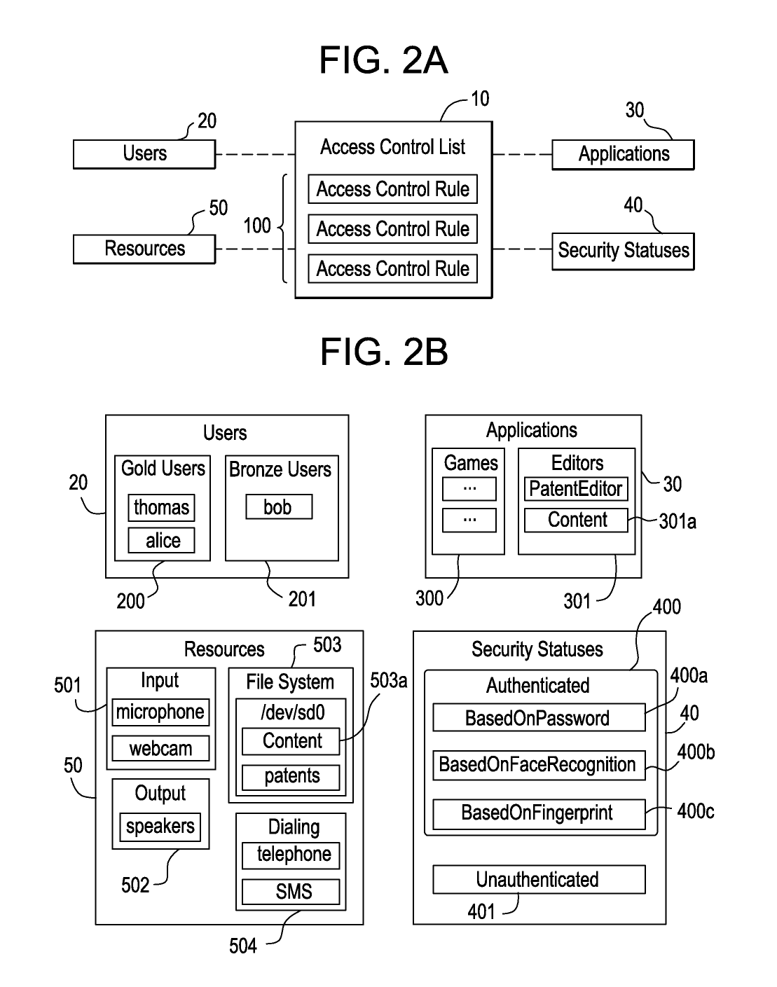

Referring to FIG. 2a there is depicted parameters that may be associated with an innovative access control data structure 10 (e.g., ACL) in accordance with an embodiment of the invention. As shown, the parameters may comprise users 20, applications 30, security statuses 40 and distributed resources 50. In an embodiment of the invention the security statuses may comprise levels of security that may be granted to a user or application, for example. Further, each of the security statuses may be associated with one or more authentication processes. As shown ACL 10 may comprise ACRs 100 that may be used to grant or deny users 20 and/or applications 30 access to distributed resources 50 based on completion of an authentication process within statuses 40.

In addition to the parameters shown in FIG. 2a, and in accordance with additional, embodiments of the invention, a user or application may be granted or denied access to a variable number and type of distributed resources depending upon innovative “session” statuses. In accordance with one embodiment of the invention a session status may comprise an activity status. That is, at a given moment in time or during a certain time frame a user may be engaged in a particular activity (or lack thereof), such as a gaming activity, work-related activity, or web browsing activity, for example. Accordingly, the number and type of distributed resources a user or application may be granted or denied access to may vary depending upon the user's activity status. For example, a user may, or may not, be actively engaged in a gaming session, in which case an activity status may be represented as “actively involved in gaming” or “no longer actively involved in gaming”.

Alternatively, a session status may comprise a particular state of an application. Accordingly, a session status may also comprise an application status. For example, if a user is downloading an audio or video file an application status may be “downloading an audio file” or “downloading a video file”. It should be understood that an activity status and application status are just two examples of the many session statuses that may be used to control access to distributed resources in accordance with the present invention. A session status may be detected or otherwise determined by one of the devices shown in FIG. 1, such as local device 2a, for example.

The consideration of a session status in granting or denying (i.e., controlling) access to distributed resources may provide a user or systems administrator with the ability to customize how distributed resources are accessed on a user-by-user, or application-by-application basis. Said another way, the distributed resources that may be accessed may vary from one time period to another depending upon whether there is a change in a session status. Further, in an embodiment of the invention, an innovative ACL may associate an authentication process or level (collectively referred to as “process”) with one session status and a higher or lower (i.e., stricter or less strict) authentication process with another, different session status. Said another way, the innovative access control data structures (ACLs/ACRs) provided by the present invention may vary the authentication process/level required to access distributed resources from one session status to another. So, for example, if a group of users are involved in a gaming application, and one of the users needs to access a word processing application, such a user may do so without fear that the other users and their applications may inadvertently (or otherwise) gain access to the word processing application and its associated files, folders, and documents by configuring an appropriate ACL. In particular, generating an ACL that has been configured using ACRs that grant access to the user upon detection of a session status, and provided the user completes an authentication process that is known only to the user, or a process that recognizes the user and distinguishes the user from all other users, for example.

With the above in mind, in an embodiment of the invention a method for controlling access to distributed resources 50 may comprise determining a session status of one or more users at a device within network 1, and then controlling access to one or more particular distributed resources within resources 50 associated with the device (e.g., local devices 2,4 or network device 6) based on the determined session status and an access control data structure, such as an ACL; in particular ACRs within an ACL. For example, an inventive method may determine that a user 20 is actively engaged in an on line gaming session (session status), and then grant the user access to an audio driver and modem (resources) associated with device 2 to allow the user to communicate with other individuals participating in the on line gaming session provided the user has completed an authorization process, in accordance with an innovative ACL and associated ACRs. Conversely, the inventive method may additionally determine that the user 20 is not actively engaged in a work session (session status), and, therefore, deny the user 20 access to documents associated with folders (resources) 50 associated with device 2 provided access to the documents has been restricted (not authorized) at device 2 in accordance with an innovative ACL and associated ACRs. Denial of such access may be based on many rationales, such as preventing the user 20 from mistakenly or inadvertently corrupting such documents during the on line gaming session, for example.

In accordance with the present invention, one of the devices depicted in FIG. 1, such as device 2, may be operable to receive the distributed access control data structures, such as ACL 10, as well as one or more additional, distributed ACLs from a device within the network 1 (such as device 6) or from a device outside of the network 1. As mentioned previously, it should be understood that a distributed access control data structure, such as ACL 10, may be generated by a number of different devices/methods within network 1. For example, a user with special privileges (e.g., system administrator) may have the right to generate and configure ACLs and ACRs after being authenticated, for example. In another embodiment, a user without such privileges may have the right to create, modify or otherwise administer ACLs and ACRs associated with distributed resources. In either case, the generation of an ACL and associated ACRs may be adapted to a particular file-system that may be part of a device that a user may use to generate the ACLs and ACRs. For example, most operating systems are operable to identify an “owner” of a resource that is typically registered on a file-system by analyzing meta-data associated with the resource. In other words the meta-data may reveal the identity of the owner as well as identify whether the identified owner may have the right to generate and/or modify ACRs associated with the resource. In another embodiment, an operating system may be operable to identify whether a user has the right to access, generate, delete or modify ACRs and ACLs by referring to a stored access control data structure model (e.g., ACL). For example, the operating system may be operable to access a stored model in order to identify so-called “permissions” that may exist within the model, where the permissions grant a user (or users) the right (or not) to access, generate, delete or modify ACLs and ACRs, for example. Yet more specifically, a Microsoft NTFS file-system may be modified to generate, delete or modify ACRs and ACLs through the use of modified permissions such as a modified “Read Permission” or modified “Change Permission”.

Further, once generated an entire access control data structure (e.g., ACL) may be distributed to devices within the network 1, or alternatively, a portion of such a data structure (e.g., ACL) may be distributed to devices within the network 1. In the scenario where a device generating an ACL is also the device that uses the so generated ACL, it should be understood that the phrases “distributed”, “distributing” or any other grammatical tense of the word “distribute” may include a meaning that includes the use of a generated ACL by the device responsible for generating the ACL. Yet further, an access control data structure (ACL) may be distributed by a device or devices that are outside of the network 1, or distributed to a device or devices that are outside of the network 1.

Continuing, upon receiving one or more distributed ACLs the device 2, for example, may be operable to associate the one or more received ACLs with an OS of the device 2 in order to facilitate the use of the received ACLs to control access to distributed resources, such as resources 50. In accordance with embodiments of the invention the OS may be selected from the group consisting of at least a Linux-based OS, a UNIX based OS, a Microsoft based OS, an Apple based OS, another known OS or may be a run-time system or file-system.

Referring now to FIG. 2b there is depicted additional exemplary parameters that may be associated with an access control data structure, such as ACL 10. FIG. 2b includes more specific examples of parameters that may be included in the generalized parameters shown in FIG. 2a.

As shown, user parameter 20 may comprise exemplary user parameters 200, 201 each of which may identify a specific user or group of users, and application parameter 30 may comprise exemplary application parameters 300, 301, each of which may identify a specific application, (e.g., content distribution application 301a). Further, an authentication parameter 40 may comprise exemplary authentication parameters 400, 401 each of which may identify a specific authentication process while a resource parameter 50 may comprise exemplary, distributed resources 501 through 504, each of which may identify a specific, distributed resource. In accordance with the present invention, the parameters shown in FIG. 2b may be associated with one or more ACLs and associated ACRs for controlling access to distributed resources 50. As before, one exemplary ACL may grant or deny a user 200,201 or application 300, 301 access to a resource 501 to 504 after considering a session status and completion of an authentication process.

Previously it was mentioned that innovative access control data structures (ACLs/ACRs) provided by the present invention may vary the authentication process required to access distributed resources from one session status to another. It follows then that the distributed resources that may be accessed may vary from one time period to another depending upon whether there is a change in a session status. Accordingly, in embodiments of the invention one or more devices shown in FIG. 1 may be operable to continuously determine a session status, and, thereafter, determine access to distributed resources in accordance with an ACL. More specifically, after a present session status is determined, one or more of the devices shown in FIG. 1 may be operable to determine a next session status. That is, after a time period elapses a device, such as device 2, may be operable to determine that the status of a user 20 or application 30 has changed (e.g., a user switches from active involvement in a gaming application to inactive participation, or an application switches from printing out a document to halting the printing process). In an embodiment of the invention the device 2, upon determining that a session status has changed, may be operable to determine a next authentication process in accordance with an innovative ACL and associated ACRs to control access to the one or more distributed resources 50. As mentioned above, the next authentication process may represent a more, or less stringent authentication process. For example, if a present or previous authentication process is based on a password recognition (subprocess 400a) the next authentication process may require facial recognition (subprocess 400b), or fingerprint recognition (subprocess 400c) or no authentication process 401 at all. More specifically, a user 20 may be granted, or denied, access to a distributed resource 50 once the determined, next authentication process is completed in accordance with an innovative ACL and associated ACRs. Alternatively, an application 30 may be granted, or denied, access to a distributed resource 50 once the determined, next authentication process is completed in accordance with an innovative ACL and associated ACRs.

In the description set forth above the session status may be unrelated to a specific application. Instead, the session status may be related to a user's activity. In an alternative embodiment, a session status may be related to an application 30. For example, if a session status is “upload a video” this session status may be related to a content distribution application. Further, substantially all of the session statuses determined by a device, such as device 2, may relate to a specific application (e.g., to a content distribution application). In an embodiment of the invention, a device shown in FIG. 1, such as device 2, may be operable to determine a session status that is associated with a specific application 30, and, thereafter, further operable to control access to one or more distributed resources 50 (e.g., content 503a within file system 503) based on the determined session status and one or more access control data structures, such as ACL 10. In particular the device 2 may be operable to grant or deny a user 30, the specific application or another application 30, access to one or more distributed resources 50 based on completion of the determined authentication process in accordance with an innovative ACL and associated ACRs. In an embodiment of the invention, one or more of the devices within network 1 may be operable to receive content from one or more additional devices within the network 1. Thereafter, upon being granted access to the received content one or more of such devices may be operable to access any received content.

It was noted earlier that the phrase “user” may cover multiple users and the phrase “application” may cover multiple applications. Thus, it should be understood that the embodiments of the invention described herein and their equivalents are intended to cover a plurality of users, applications, and resources, that may be logically grouped and re-grouped in multiple and nested hierarchies, and that one or more access control data structures (e.g., ACLs/ACRs) may be specified for an entire group, including any element within a group. In embodiment of the invention, different access control data structures (ACLs/ACRs) may apply to the same combination of elements. Accordingly, if a conflict should occur the present invention provides for conflict resolution mechanisms to provide consistent, well-defined resolutions. For example, in one embodiment a device may select a specific access control data structure over a less specific data structure upon detection of a conflict between applicable data structures. That is to say, a more specific or specific access control data structure may take precedence over a general, or less specific data structure and, therefore, may be selected and applied by a device before applying the less specific data structures. In another embodiment, access control rules generated by an individual with special privileges (systems administrators) may take precedence over those generated by individuals without such privileges, and, therefore may be selected and applied before applying rules generated by non-privileged users depending on the context specified by the OS, run-time system or file-system within which the data structure(s) may be embedded or otherwise associated.

The application or usage of an access control data structure (ACL) and its associated rules (ACRs) described herein may be triggered, applied or otherwise referenced in accordance with embodiments of the invention. For example, in one embodiment reference to (or application of) an ACL and associated ACRs may occur when an application, running on behalf of a user, attempts to access a particular resource, through some resource-specific API made available within an operating system. For example, UNIX based operating systems that are configured according to an “everything-is-a-file” design concept may be operable to allow access to resources such as a disk-based file-system, and peripherals through the use of a small set of standard system “calls” (e.g., instructions executed by a processor to initialize a process or a set of additional instructions). The system calls may be used to open, read, write and close a file, and perform additional configurations through input/output control operations. In additional embodiments, other operating systems may use a different design concept and define specific APIs for accessing ACLs and associated ACRs that, in turn, control access to resources such as cameras, microphones or speakers. In more detail, in embodiments of the invention, upon execution and/or detection of a system call (or hypervisor call, software interrupt, or any other type of local or remote invocation) that may represent a request or trigger to access a resource, an operating system may locate ACLs and ACRs associated with a particular application (or user the application is acting on behalf of) that may have generated the system call in order to determine the resources the application/user may be granted (or denied) access to, taking into consideration the type of operation requested (or being attempted), and a session status (e.g., status of a user, application and/or system session). Further, special error values may be generated by the operating system, for example, when an application or user is denied or granted access to a resource due to, for example, security restrictions (e.g., a modified EACCESS for UNIX system calls). Yet further, in alternative embodiments, these special error values may be not be generated when access to a resource is granted or denied. That is, instead of indicating that access is denied, for example, modified error values may be generated that indicate that access “may be denied”, or “apparently granted” or “apparently denied”. The rationale for providing such indications and the ability to provide such indications may rest with a specific user and/or systems administrator that is provided with the ability to configure an access control data structure (ACLs/ACRs). That is, ACL/ACRs may be configured to allow additional outcomes other than access granted or access denied.

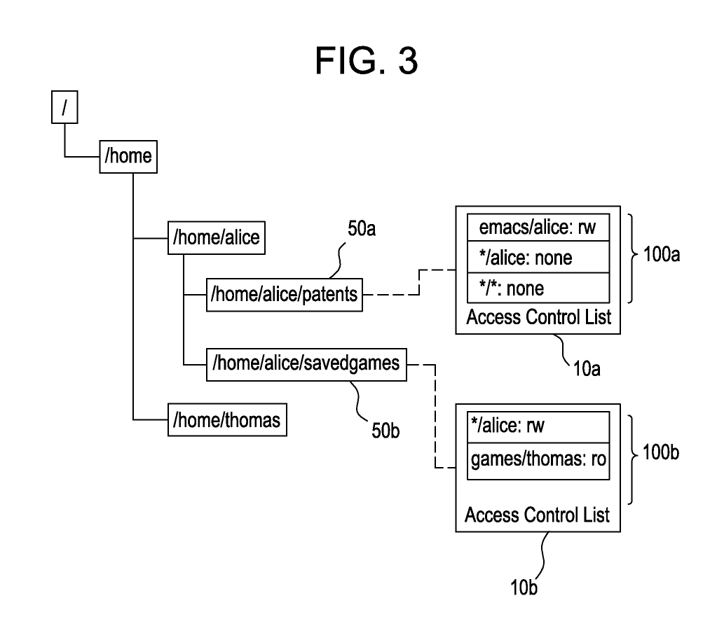

FIG. 3 depicts some specific, exemplary ACRs 100a,b in accordance with embodiments of the invention. As shown, ACLs 10a,b each comprise ACLs 100a,b, respectively. In the exemplary embodiment shown in FIG. 3, access to file level, distributed resources 50a,b identified, for example, by file extensions may be granted using ACLs 10a,b and ACRs 100a,b. In more detail, the folder “patents” within a “home” directory of a user named “Alice” may be accessed by an application called “emac” (text editor). However, this folder may not be accessed by another user or application. In contrast, the folder “saved games” within the user Alice's home directory may be accessed by Alice in a “READ/WRITE” mode and also accessed by applications within a “games” group when acting on behalf of a user named “Thomas”.

While exemplary embodiments have been shown and described herein, it should be understood that variations of the disclosed embodiments may be made without departing from the spirit and scope of the invention. For example, other access control data structures other than ACLs, or sets of access control rules other than ACRs, may be implemented within the scope of the invention, all of which may be encompassed by the claims that follow.

What is claimed is:

1. A method for controlling access to distributed resources comprising:
determining a session status at a device within a cloud-based network;
determining an authentication process based on the determined session status in accordance with an access control data structure; and
controlling access to one or more distributed resources based on the data structure.

2. The method as in claim 1 wherein the access control data structure comprises one or more access control lists.

3. The method as in claim 1 further comprising:
receiving the access control data structure at the device; and
associating the received access control data structure with an operating system (OS) of the device.

4. The method as in claim 1 further comprising granting or denying a user or application access to the one or more distributed resources based on the access control data structure.

5. The method as in claim 4 wherein the application comprises a content distribution application.

6. The method as in claim 1 further comprising:
determining a next session status;
determining a next authentication process based on the determined next session status in accordance with the access control data structure; and
controlling access to the one or more distributed resources based on the access control data structure.

7. The method as in claim 1 further comprising selecting a specific access control data structure over a less specific data structure upon detection of a conflict between data structures.

8. The method as in claim 1 wherein the device is selected from the group consisting of at least a local device, and a network device.

9. The method as in claim 3, wherein the OS is selected from the group consisting of at least a Linux based OS, a UNIX based OS, a Microsoft based OS, and an Apple based OS.

10. The method as in claim 1 further comprising receiving content at the device from one or more additional devices within the cloud-based network.

11. A method for controlling access to distributed resources comprising:
generating an access control data structure at a device within a cloud-based network, the structure associated with one or more parameters selected from the group consisting of at least users, applications, authentication processes and distributed resources; and
distributing the access control data structure to one or more additional devices within the cloud-based network.

12. The method as in claim 11 further comprising distributing a portion of the access control data structure to one of the additional devices within the cloud-based network.

13. The method as in claim 11 wherein the access control data structure comprises one or more access control lists.

14. The method as in claim 11 wherein the one or more additional devices are selected from the group consisting of at least local devices, and network devices.

15. The method as in claim 11 wherein the device is selected from the group consisting of at least a local device, and a network device.

16. The method as in claim 11 wherein one of the applications comprises a content distribution application.

17. The method as in claim 11 further comprising distributing content to the one or more additional devices.

18. A device for controlling access to distributed resources, the device operable to:
determine a session status;
determine an authentication process based on the determined session status in accordance with an access control data structure; and
control access to one or more distributed resources based on the data structure.

19. The device as in claim 18 wherein the access control data structure comprises one or more access control lists.

20. The device as in claim 19 further operable to:
receive the access control data structure; and
associate the received access control data structure with an operating system (OS).

21. The device as in claim 18 further operable to grant or deny a user or application access to the one or more distributed resources based on the access control data structure.

22. The device as in claim 21 wherein the application comprises a content distribution application.

23. The device as in claim 18 further operable to:
determine a next session status;
determine a next authentication process based on the determined next session status in accordance with the access control data structure; and
control access to the one or more distributed resources based on the access control data structure.

24. The device as in claim 18 further operable to select a specific access control data structure over a less specific data structure upon detection of a conflict between data structures.

25. The device as in claim 18 wherein the device is selected from the group consisting of at least a local device, and a network device.

26. The device as in claim 20, wherein the OS is selected from the group consisting of at least a Linux based OS, a UNIX based OS, a Microsoft based OS, and an Apple based OS.

27. The device as in claim 18 further operable to receive content from one or more additional devices within the cloud-based network.

28. A device for controlling access to distributed resources, the device operable to:
generate an access control data structure, the structure associated with one or more parameters selected from the group consisting of at least users, applications, authentication processes and distributed resources; and
distribute the access control data structure to one or more additional devices within a cloud-based network.

29. The device as in claim 28 further operable to distribute a portion of the access control data structure to one of the additional devices within the cloud-based network.

30. The device as in claim 28 wherein the access control data structure comprises one or more access control lists.

31. The device as in claim 28 wherein the one or more additional devices are selected from the group consisting of at least local devices, and network devices.

32. The device as in claim 28 wherein the device is selected from the group consisting of at least a local device, and a network device.

33. The device as in claim 28 wherein one of the applications comprises a content distribution application.

34. The device as in claim 28 further operable to distribute content to the one or more additional devices.
